(19) United States
(12) Patent Application Publication
(10) Pub. No.: US 2026/0066586 A1
(43) Pub. Date: Mar. 5, 2026

(54) ELECTRONIC ASSEMBLY HAVING A CABLE CONNECTOR MODULE

(71) Applicants: TE Connectivity Solutions GmbH, Schaffhausen (CH); Tyco Electronics (Shanghai) Co., Ltd., Shanghai (CN)

(72) Inventors: Blake Dunbar, Middletown, PA (US); Kevin Stauffer, Fremont, CA (US); Chad William Morgan, Carneys Point, NJ (US); Jiwang Jin, Shanghai (CN); Michael Eugene Shirk, Grantville, PA (US); Craig Warren Hornung, Harrisburg, PA (US); Julia Anne Lachman, York, PA (US); Matthew Jeffrey Sypolt, Harrisburg, PA (US); Jeff Swartzbaugh, Dover, PA (US)

(21) Appl. No.: 18/825,303

(22) Filed: Sep. 5, 2024

(51) Int. Cl. H01R 13/652; H01R 12/75; H01R 13/514; H01R 13/6591; H01R 13/6592

(52) U.S. Cl. CPC H01R 13/652; H01R 12/75; H01R 13/514; H01R 13/65914; H01R 13/6592

(57) ABSTRACT

A cable connector module includes a housing includes contact pockets and contact modules received in the corresponding contact pockets. Each contact module includes a contact holder holding contacts in pairs. The cable connector module includes cables having cable ends terminated to the contact modules. The cable connector module includes ground cages associated with the cables and the corresponding contact modules. Each ground cage provides circumferential shielding around the cable end of the corresponding cable and around the contact modules. The ground cage is electrically connected to the cable shield of the corresponding cable and is mechanically coupled to the housing.

### BACKGROUND OF THE INVENTION

The subject matter herein relates generally to communication systems.

There is an ongoing trend toward smaller, lighter, and higher performance communication components and higher density systems, such as for ethernet switches or other system components. Typically, the system includes an electronic package coupled to a circuit board, such as through a socket connector. Electrical signals are routed between the electronic package and the circuit board. The electrical signals are then routed along traces on the circuit board to another component, such as a transceiver connector. The long electrical paths through the host circuit board reduce electrical performance of the system. Additionally, losses are experienced between the connector interfaces and along the electrical signal paths of the transceivers. Conventional systems are struggling with meeting signal and power output from the electronic package. Some known systems utilize an electronic assembly having cable assemblies to transmit the signals along cables rather than signal traces along the host circuit board. However, the electronic assembly includes numerous cables terminated to a circuit card. There is a need to increase the density of the cables and the contact pads on the circuit card to reduce the overall size of the electronic assembly. However, there are limits to spacing of the contact pads to allow routing of the cables from the circuit card with conventional cable termination techniques. For example, ample spacing is needed between rows of the circuit cards to allow routing of the cables along the circuit card. Additionally, as data speeds increase, the shielding (for example, return path) at the interface between the cables and the circuit card is proving ineffective, particularly at higher frequencies.

### BRIEF DESCRIPTION OF THE INVENTION

In one embodiment, a cable connector module is provided and includes a housing having contact pockets. The cable connector module includes contact modules received in the corresponding contact pockets. Each contact module includes a contact holder holding contacts in pairs. Each contact includes a connecting end configured to be mated with a mating conductor and a terminating end opposite the connecting end. The cable connector module includes cables having cable ends terminated to the contact modules. Each cable includes a pair of signal conductors. The signal conductors terminated to the terminating ends of the corresponding contacts to electrically connect the cables to the corresponding contact modules. Each cable has a cable shield surrounding the pair of signal conductors. The cable connector module includes ground cages associated with the cables and the corresponding contact modules. Each ground cage provides circumferential shielding around the cable end of the corresponding cable and around the contact modules. The ground cage is electrically connected to the cable shield of the corresponding cable. The ground cage is mechanically coupled to the housing.

In another embodiment, a cable connector module is provided and includes a circuit card and a cable assembly coupled to the circuit card. The circuit card includes a substrate having contact pads. The cable assembly includes a housing mounted to the substrate. The housing includes contact pockets. The cable assembly includes contact modules received in the corresponding contact pockets. Each contact module includes a contact holder holding contacts in pairs. Each contact includes a connecting end configured to be mated with the corresponding contact pad of the circuit card and a terminating end opposite the connecting end. The cable assembly includes cables having cable ends terminated to the contact modules. Each cable includes a pair of signal conductors. The signal conductors terminated to the terminating ends of the corresponding contacts to electrically connect the cables to the corresponding contact modules. Each cable has a cable shield surrounding the pair of signal conductors. The cable assembly includes ground cages associated with the cables and the corresponding contact modules. Each ground cage provides circumferential shielding around the cable end of the corresponding cable and around the contact modules. The ground cage is electrically connected to the cable shield of the corresponding cable. The ground cage is mechanically coupled to the housing.

In a further embodiment, a communication system is provided and includes a first electrical connector and a second electrical connector configured to be mated at a separable mating interface. The first electrical connector comprising a cable connector module includes a housing includes contact pockets, contact modules received in the corresponding contact pockets, cables having cable ends terminated to the contact modules, and ground cages associated with the cables and the corresponding contact modules. Each contact module includes a contact holder holding contacts in pairs with each contact including a connecting end and a terminating end opposite the connecting end. Each cable includes a pair of signal conductors. The signal conductors terminated to the terminating ends of the corresponding contacts to electrically connect the cables to the corresponding contact modules. Each cable has a cable shield surrounding the pair of signal conductors. Each ground cage provides circumferential shielding around the cable end of the corresponding cable and around the contact modules. The ground cage is electrically connected to the cable shield of the corresponding cable. The ground cage is mechanically coupled to the housing. The second electrical connector includes mating contacts. Each mating contact is configured to be electrically connected to the connecting end of the contact of the corresponding contact module.

In another embodiment, a cable assembly for a cable connector module is provided. The cable assembly includes cables having cable ends. Each cable includes a first signal conductor, a second signal conductor, and a cable shield surrounding the pair of signal conductors. The cable assembly includes contact modules terminated to the cable ends of the corresponding cables. Each contact module includes a contact holder holding a first contact and a second contact. The first contact has a terminating end terminated to the first conductor. The second contact has a terminating end terminated to the second conductor. The first and second contacts include connecting ends configured to be mated with mating conductors. The cable assembly includes ground cages associated with the cables and the corresponding contact modules. Each ground cage includes a ferrule and a cover coupled to the ferrule. The ferrule includes a bottom wall, a first side wall extending from a first side of the bottom wall, and a second side wall extending from a second side of the bottom wall. The bottom wall, the first side wall, and the second side wall form a cradle receiving the cable end of the corresponding cable. The cover coupled to the first and second side walls to cover the cradle. The bottom wall is coupled to a bottom of the cable shield. The first side wall is coupled to a first side of the cable shield. The second side wall is coupled to a second side of the cable shield, and the cover is coupled to a top of the cable shield to provide circumferential shielding around the cable end of the corresponding cable.

In another embodiment, a cable assembly for a cable connector module is provided. The cable assembly includes cables having cable ends. Each cable includes a first signal conductor, a second signal conductor, and a cable shield surrounding the pair of signal conductors. The cable assembly includes contact modules terminated to the cable ends of the corresponding cables. Each contact module includes a contact holder holding a first contact and a second contact. The first contact has a terminating end terminated to the first conductor. The second contact has a terminating end terminated to the second conductor. The first and second contacts include connecting ends configured to be mated with mating conductors. The cable assembly includes ground cages associated with the cables and the corresponding contact modules. Each ground cage provides circumferential shielding around the cable end of the corresponding cable and around the corresponding contact modules. The ground cage is electrically connected to the cable shield of the corresponding cable on at least four sides of the cable shield.

In a further embodiment, a cable assembly for a cable connector module is provided. The cable assembly includes a housing that includes contact pockets. The housing is conductive to provide shielding for the contact pockets. The cable assembly includes cables having cable ends. Each cable includes a first signal conductor, a second signal conductor, and a cable shield surrounding the pair of signal conductors. The cable assembly includes contact modules received in the corresponding contact pockets. The contact modules terminated to the cable ends of the corresponding cables. Each contact module includes a contact holder holding a first contact and a second contact. The first contact has a terminating end terminated to the first conductor. The second contact has a terminating end terminated to the second conductor. The first and second contacts include connecting ends configured to be mated with mating conductors. The cable assembly includes ground cages associated with the cables and the corresponding contact modules. Each ground cage includes a ferrule having a cradle receiving the cable end of the corresponding cable and a cover covering the cradle. The ferrule and the cover are electrically connected to the cable shield of the corresponding cable to provide circumferential shielding around the cable end of the corresponding cable. The ferrule includes a ferrule tab coupled to the housing to electrically connect the ferrule to the housing. The cover includes a cover tab coupled to the housing to electrically connect the cover to the housing.

### BRIEF DESCRIPTION OF THE DRAWINGS

FIG. 1 is a perspective view of a communication system having an electronic assembly in accordance with an exemplary embodiment.

FIG. 2 is an exploded view of the electronic assembly in accordance with an exemplary embodiment.

FIG. 3 is an exploded view of the cable connector module in accordance with an exemplary embodiment.

FIG. 4 is a perspective view of the housing in accordance with an exemplary embodiment.

FIG. 5 is a top view of the housing in accordance with an exemplary embodiment.

FIG. 6 is a top view of a portion of the housing in accordance with an exemplary embodiment.

FIG. 7 is a top perspective view of a portion of the housing in accordance with an exemplary embodiment.

FIG. 8 is a rear perspective view of the ferrule in accordance with an exemplary embodiment.

FIG. 9 is a top perspective view of the ferrule in accordance with an exemplary embodiment.

FIG. 10 is a front perspective view of the ferrule in accordance with an exemplary embodiment.

FIG. 11 is a front perspective view of the cover of the ground cage in accordance with an exemplary embodiment.

FIG. 12 is a rear perspective view of the cover of the ground cage in accordance with an exemplary embodiment.

FIG. 13 is a perspective view of a portion of the cover in accordance with an exemplary embodiment.

FIG. 14 illustrates a portion of the cable assembly showing the cable poised for loading into the ferrule in accordance with an exemplary embodiment.

FIG. 15 illustrates a portion of the cable assembly showing the cable loaded into the ferrule in accordance with an exemplary embodiment.

FIG. 16 illustrates a portion of the cable connector module in accordance with an exemplary embodiment showing a plurality of the contact modules poised for loading into the housing and showing a plurality of the cable assemblies poised for loading into the housing.

FIG. 17 illustrates a portion of the cable connector module in accordance with an exemplary embodiment showing the contact module and the cable assembly loaded into the housing.

FIG. 18 is a cross-sectional view of a portion of the cable connector module in accordance with an exemplary embodiment showing the contact module and the cable assembly loaded into the housing.

FIG. 19 illustrates a portion of the cable connector module in accordance with an exemplary embodiment showing the cover poised for coupling to the housing.

FIG. 20 illustrates a portion of the cable connector module in accordance with an exemplary embodiment showing the cover coupled to the housing.

FIG. 21 illustrates a portion of the cable connector module in accordance with an exemplary embodiment showing the cover coupled to the housing.

### DETAILED DESCRIPTION OF THE INVENTION

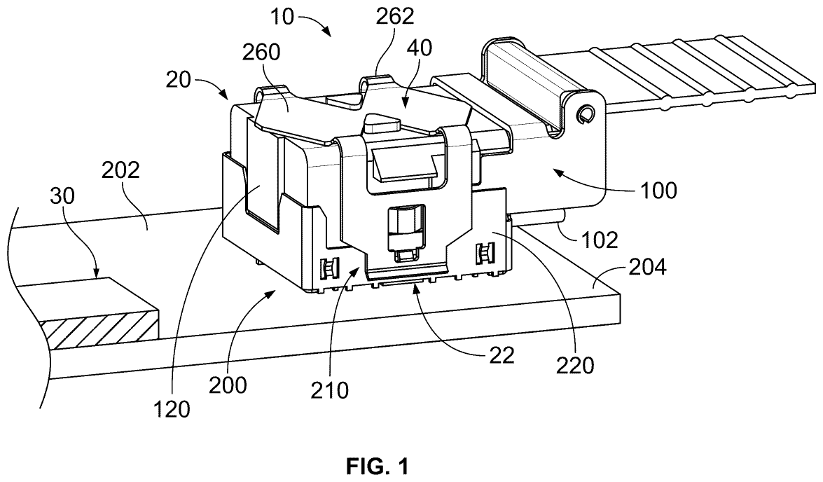

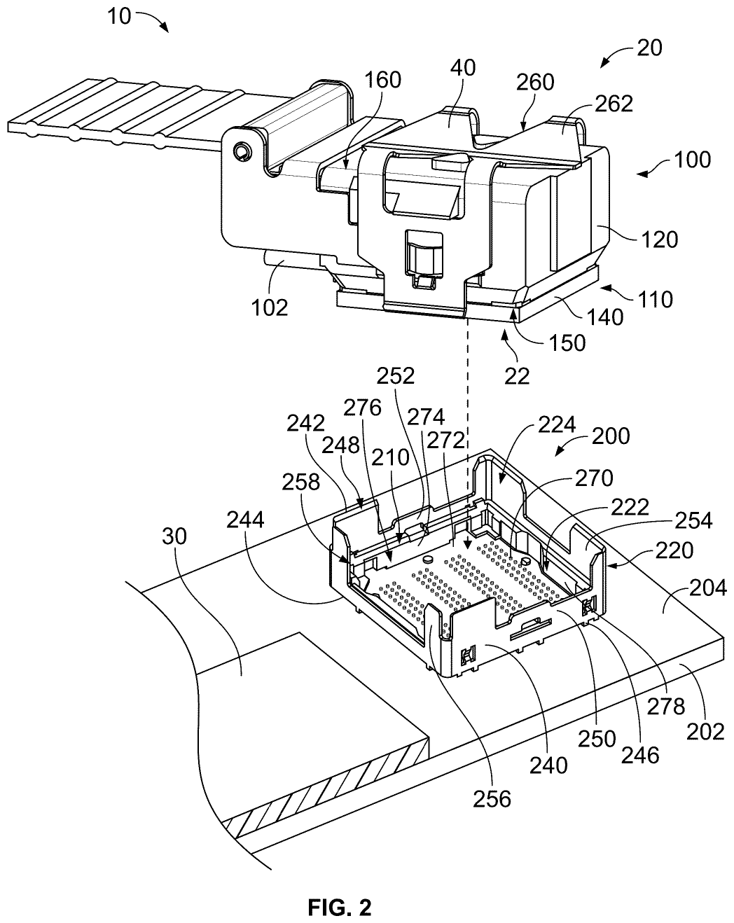

FIG. 1 is a perspective view of a communication system 10 having an electronic assembly 20 in accordance with an exemplary embodiment. FIG. 2 is an exploded view of the electronic assembly 20 in accordance with an exemplary embodiment. The electronic assembly 20 includes a first electrical connector 100 and a second electrical connector 200. The first electrical connector 100 is configured to be coupled to the second electrical connector 200 at a separable mating interface 22.

In an exemplary embodiment, the first electrical connector 100 is a cable connector. The first electrical connector 100 is provided at ends of cables 102. The first electrical connector 100 may be a plug connector configured to be plugged into the second electrical connector 200. In an exemplary embodiment, the first electrical connector 100 includes a cable connector module 110 configured to be mated with the second electrical connector 200.

In an exemplary embodiment, the second electrical connector 200 is a board connector mounted to a circuit board 202. For example, the second electrical connector 200 may be a receptacle connector or a header connector. The second electrical connector 200 may be a card edge connector having a card slot and the first electrical connector 100 may include a card edge configured to be plugged into the card slot. In an exemplary embodiment, the second electrical connector 200 includes a socket assembly 210 mounted to the circuit board 202. The first electrical connector 100 is configured to be plugged into the socket of the socket assembly 210. The socket assembly 210 is used to electrically connect the corresponding cable connector module 110 to the circuit board 202. In other various embodiments, the second electrical connector 200 may be a cable connector provided at ends of cables (not shown).

In an exemplary embodiment, the communication system 10 includes an electronic package 30 electrically connected to the circuit board 202. In various embodiments, the electronic package 30 may be an integrated circuit assembly, such as an ASIC. However, the electronic package 30 may be another type of communication component. The electronic package 30 may be mounted directly to the circuit board 202. For example, the electronic package 30 may be soldered to the circuit board 202. The cable connector module 110 is electrically connected to the electronic package 30 through the socket assembly 210 and the circuit board 202. One electronic assembly 20 (socket assembly 210 and corresponding cable connector module 110) is shown on one side of the electronic package 30 in FIGS. 1 and 2. However, it should be understood that multiple electronic assemblies 20 may be provided at one or more sides, such as all four sides of the electronic package 30, in alternative embodiments. The cable connector modules 110 are electrical modules using electrical conductors to transmit electrical data signals to/from the electronic package 30. In an exemplary embodiment, the socket assembly 210 and corresponding cable connector module 110 are low profile connectors having a low profile or height measured from the top of the circuit board 202, such as to allow other components, such as a heat sink or other heat transfer device, to thermally couple to the electronic package 30.

In an exemplary embodiment, compression elements 40 are used to load the cable connector modules 110 against the socket assemblies 210 to electrically connect the cable connector modules 110 to the socket assemblies 210 and to electrically connect the socket assemblies 210 to the circuit board 202. For example, the compression elements 40 may include springs and/or clips and/or compression hardware that press the components downward to load the socket assemblies 210 and create mechanical and electrical connections between the cable connector modules 110 and the socket assemblies 210. In various embodiments, the cable connector modules 110 are individually clamped or compressed against the socket assemblies 210 by the compression elements and are thus individually serviceable and removable from the socket assemblies 210.

In an exemplary embodiment, the communication system 10 includes heat dissipating elements (not shown) to dissipate heat from the electronic package 30 and/or the cable connector modules 110.

The socket assembly 210 is used to electrically connect the cable connector module 110 to the circuit board 202. The socket assembly 210 is mounted to the circuit board 202. For example, the socket assembly 210 is mounted to a mounting area on an upper surface 204 of the circuit board 202. The mounting area may be located adjacent to the electronic package 30. The circuit board 202 includes board contacts (not shown) at the mounting area. The board contacts may be arranged in an array, such as in rows and columns. The board contacts may be pads or traces of the circuit board 202. The board contacts may be high speed signal contacts, low speed signal contacts, ground contacts, or power contacts. The board contacts may include pairs of high-speed signal board contacts surrounded by a ring or fence of ground board contacts and/or a ground plane.

In an exemplary embodiment, the socket assembly 210 includes a cage 220 and a socket connector 222 arranged in a cavity 224 of the cage 220. The cavity 224 receives the cable connector module 110 to mate with the socket connector 222 of the socket assembly 210. The cage 220 guides mating of the cable connector module 110 with the socket connector 222.

In an exemplary embodiment, the cage 220 is a stamped and formed cage configured to be stamped and formed from a metal sheet. The cage 220 includes cage walls 240 defining the cavity 224. The cage walls 240 extend between a top 242 and a bottom 244 of the cage 220. The bottom 244 is configured to be coupled to the circuit board 202. In an exemplary embodiment, the cage 220 includes mounting tabs 246 configured to be mounted to the circuit board 202. The mounting tabs 246 may extend from the bottom 244. The mounting tabs 246 may include openings configured to receive fasteners, such as threaded fasteners, used to couple the cage 220 to the circuit board 202. Other types of mounting tabs may be used in alternative embodiments, such as press fit pins, weld tabs, solder tabs, slips, latches, threaded openings, or other types of mounting features. In alternative embodiments, separate securing features may be used to secure the cage 220 to the circuit board 202. In an exemplary embodiment, the cage 220 includes a top opening 248 at the top 242. The top opening 248 is configured to receive the cable connector module 110. For example, the cable connector module 110 is top loaded into the cavity 224 through the top opening 248.

In an exemplary embodiment, the cage 220 includes side walls 250, 252 and end walls 254, 256. The side walls 250, 252 may be shorter than the end walls 254, 256. In the illustrated embodiment, the end wall 256 includes an opening 258. The opening 258 is configured to receive a portion of the cable connector module 110, such as the cables. In an exemplary embodiment, the cage 220 includes latching features 260 used for latchably coupling to the cable connector module 110. For example, the latching features 260 interface with the latches of the cable connector module 110 and/or a spring clip 262 used to secure the cable connector module 110 in the cage 220. The spring clip 262 engages the top of the cable connector module 110 and presses against the top of the cable connector module 110. The spring clip 262 presses the cable connector module 110 toward the socket connector 222 to electrically connect the cable connector module 110 to the socket connector 222. The latching features 260 may be deflectable latches. Other types of latching features may be used in alternative embodiments, such as latch openings. The latching features 260 are provided at the side walls 250, 252 in the illustrated embodiment. However, the latching features 260 may be provided at other locations in alternative embodiments.

The socket connector 222 includes an array of interposer contacts 270 held together by a substrate 272. The socket connector 222 may include a socket frame 274 holding the substrate 272. The socket frame 274 may be rectangular. The socket frame 274 is configured to be coupled to the cage 220. Additionally, or alternatively, the socket frame 274 may be coupled to the circuit board 202. In an exemplary embodiment, the socket frame 274 includes an opening 276 that receives the substrate 272. The substrate 272 may fill the opening 276. The opening 276 may receive a portion of the cable connector module 110, such as for mating with the interposer contacts 270. The socket frame 274 includes frame members 278 defining the opening 276. In the illustrated embodiment the socket frame 274 is rectangular having the frame members 278 arranged around the perimeter of the socket frame 274 (for example, in a rectangular configuration). The socket frame 274 is configured to be coupled to the cage 220 and/or the circuit board 202.

In various embodiments, the substrate 272 is a printed circuit board including the interposer contacts 270 coupled to the printed circuit board. The interposer contacts 270 may be defined by circuits, traces, vias, and the like of the printed circuit board. The interposer contacts 270 may be separate contacts soldered to the printed circuit board.

In other embodiments, the substrate 272 is a film or plate and the interposer contacts 270 are separate contacts which may be held by or coupled to the film. The substrate 272 is manufactured from an insulative material, such as a polyimide material, to electrically isolate the interposer contacts 270 from one another.

In an exemplary embodiment, the interposer contacts 270 are compressible contacts. In various embodiments, the interposer contacts 270 may be stamped and formed contacts, such as dual compression contacts having spring beams at both ends of the contacts and main bodies of the contacts between the spring beams held in the substrate 272. The interposer contacts 270 may be LGA contacts.

In various embodiments, the interposer contacts 270 are conductive polymer columns. The conductive polymer contacts may be conductive elastomeric connectors having conductive (metallic) particles embedded in an elastomeric material, such as a silicone rubber material. Each interposer contact 270 includes an upper mating interface and a lower mating interface. In various embodiments, the interposer contacts 270 are dual compressible contacts that are compressible at both the upper mating interface and the lower mating interface, such as for mating with the cable connector module 110 and the circuit board 202, respectively. Optionally, the interposer contacts 270 may be arranged in groups, with each group including a pair of signal contacts surrounded by a ring or fence of ground contacts. The groups are arranged in rows and columns. Other arrangements are possible in alternative embodiments.

In an exemplary embodiment, the cable connector module 110 includes a cable assembly 150 including a plurality of the cables 102 with corresponding contact modules and ground structures for providing circumferential shielding for each cable and contact module through the cable connector module 110. The contact modules and ground structures are configured to be electrically connected to the second electrical connector 200 to provide shielding, high speed signal paths through the communication system 10.

In an exemplary embodiment, the cable connector module 110 includes a connector housing 120 configured to receive the cable assembly 150. The connector housing 120 is configured to be coupled to the second electrical connector 200.

In an exemplary embodiment, the cable connector module 110 includes a circuit card 140 providing an interface between the cable assembly 150 and the second electrical connector 200. For example, the contact modules and the ground structure are configured to be terminated to the circuit card 140. The circuit card 140 is configured to be mated with the socket assembly 210, such as to the socket connector 222, at a separable mating interface. In alternative embodiments, the cable connector module 110 may be provided without the circuit card 140. For example, the cable assembly 150 may be directly connected to the second electrical connector 200. For example, the contact modules and the shield structure may be directly coupled to the second electrical connector 200, such as to the socket assembly 210.

In an exemplary embodiment, the cable assembly 150 includes a cable support structure 160 for the cable 102. The cable support structure 160 is used to support the cables 102 relative to each other in the connector housing 120, such as to provide strain relief for the cables 102. The cable support structure 160 may support positions of the ends of the cables 102 for connection to the circuit card 140.

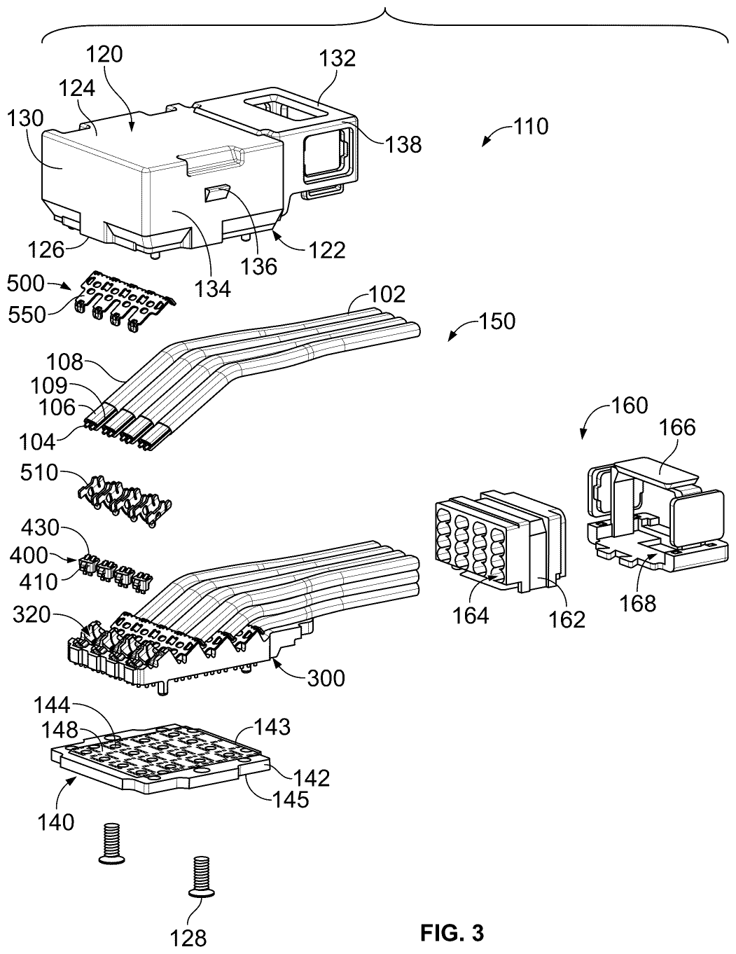

FIG. 3 is an exploded view of the cable connector module 110 in accordance with an exemplary embodiment. The cable connector module 110 includes the connector housing 120, the circuit card 140, the cable assembly 150 and the support structure 160. In an exemplary embodiment, the cable assembly 150 includes a housing 300, contact modules 400, the cables 102 terminated to the contact modules 400, and ground cages 500 associated with the cables 102 and the corresponding contact modules 400. The ground cages 500 provide circumferential shielding for the ends of the cables 102 and the contact modules 400. The housing 300 is used to support the contact modules 400, the ground cages 500, and the cables 102. In an exemplary embodiment, the housing 300 is electrically conductive to form part of the shielding structure for the signal lines to provide shielding, with the ground cages 500, through the cable assembly 150. For example, the housing 300 may provide shielding from the ground cages 500 to the circuit card 140. However, in alternative embodiments, the housing 300 is non-conductive and merely provides positioning or locating of the ground cages 500 and contact modules 400 for direct connection to the circuit card 140 or directly to the second electrical connector 200 in embodiments without the circuit card 140.

The connector housing 120 includes a housing cavity 122 that holds the cable assemblies 150 and the circuit card 140. The connector housing 120 may be a metal shell or cage that receives the cable assemblies 150. Alternatively, the connector housing 120 may be a plastic molded component. In an exemplary embodiment, the connector housing 120 extends between a top 124 and a bottom 126. The bottom 126 may be open, such as to receive the circuit card 140. The connector housing 120 extends between a front 130 and a rear 132. The rear 132 may be open to allow the cables 102 to pass into the cavity 122. In another example, the top 120 could be open for cables 102 to pass therethrough, such as when the cables 102 extend perpendicular to the circuit card 140. The connector housing 120 includes sides 134 between the front 130 and the rear 132. The connector housing 120 includes latching features 136 at the sides 134 configured to interface with the spring clip 262 and/or the socket connector 222. The connector housing 120 includes a shroud 138 at the rear 132 configured to receive the cable support structure 160. The connector housing 120 may have other shapes and/or walls in alternative embodiments.

The circuit card 140 includes a substrate 142 having an upper surface 143 and a lower surface 145. The circuit card 140 includes contact pads 144 at the upper surface 143. The contact pads 144 may be arranged in pairs. The contact pads 144 are configured to be electrically connected to the contacts of the corresponding contact modules 400. The circuit card 140 includes mating pads (not shown) at the lower surface 145 associated with the corresponding contact pads 144, such as being connected by vias. The mating pads are configured to be electrically connected to the corresponding interposer contacts 270 (shown in FIG. 2). The circuit card 140 is densely populated with the contact pads 144 and the mating pads to allow a large number of cables 102, and thus a large number of signal lines, to be electrically connected to the circuit card 140. The circuit card 140 includes a ground plane 148 and/or ground pads configured to be electrically connected to the ground cages 500 and/or the housing 300. The circuit card 140 may be secured to the connector housing 120, such as using fasteners 128.

The housing 300 includes contact pockets 320 that receive the corresponding contact modules 400 and/or the cables 102 and/or the ground cages 500. The contact pockets 320 may be arranged in an array, such as in multiple rows and/or columns. The contact pockets 320 may be open at the top and/or the bottom to receive the components. The contact pockets 320 locate the contact modules 400 relative to each other, such as for alignment and mating with the circuit card 140. The contact pockets 320 may be angled to allow the cables 102 to exit at any desired or designed angle, such as an angle between 0° and 90°. In various embodiments, the cables 102 may exit at an angle between 30° and 60° relative to the housing 300. In other various embodiments, the cables 102 may exit at an angle between 60° and 80° relative to the housing 300. In some embodiments, the cables 102 may exit at a relatively horizontal orientation (for example, between 0° and 30°). In other embodiments, the cables 102 may exit at a relatively vertical orientation (for example, between 60° and 90°). Optionally, the cables 102 in different rows may exit at different angles. The housing 300 holds the cables 102 at angles relative to the circuit card 140 to allow the cables 102 to lift off of and away from the circuit card 140, rather than laying flat or parallel to the circuit card 140. Such an arrangement allows tighter packaging of the cable assemblies, such as to increase the density of the cable connector module 110 for a given footprint of the circuit card 140.

Each contact module 400 includes a contact holder 410 holding corresponding contacts 430. In an exemplary embodiment, each contact holder 410 holds a pair of the contacts 430. The contacts 430 may be differential pairs configured to convey differential signals. The contact holder 410 holds the relative positions of the contacts 430, such as holding the contacts 430 along parallel paths through the contact module 400. The contact holder 410 may be overmolded over the contacts 430. The contacts 430 are configured to be electrically connected to the corresponding cables 102. The contacts 430 are configured to be electrically connected to the corresponding contact pads 144 of the circuit card 140. For example, the contacts 430 may include solder tails configured to be soldered to the contact pads 144. In other embodiments, the contacts 430 may include compliant pins, such as press fit pins configured to be press fit into vias in the circuit card 140. In other various embodiments without the circuit card, the contacts 430 are configured to be electrically connected directly to the second electrical connector 200 (shown in FIG. 2).

Each cable 102 includes at least one signal conductor and a shield structure providing electrical shielding for the at least one signal conductor. In an exemplary embodiment, the cables 102 are twin-axial cables. For example, each cable 102 includes first and second signal conductors 104 held by one or more insulators. The signal conductors 104 carry differential signals. The signal conductors 104 are configured to be terminated to ends of the corresponding contacts 430. The cable 102 includes a cable shield 106 surrounding the insulator and the signal conductors 104 to provide circumferential shielding around the signal conductors 104. The cable 102 includes a cable jacket 108 surrounding the cable shield 106. In various embodiments, the cable 102 includes one or more drain wires 109 electrically connected to the cable shield 106, such as a pair of drain wires 109 extending along opposite sides of the cable 102, such as between the cable shield 106 and the cable jacket 108. In an exemplary embodiment, at an end of the cable 102, the cable jacket 108, the cable shield 106, and the insulator may be removed (e.g., stripped) to expose portions of the signal conductors 104. The exposed portions of the signal conductors 104 are configured to be mechanically and electrically coupled (e.g., soldered) to corresponding contacts of the contact module 400.

The cable support structure 160 is used to support the cables 102 relative to each other. The cable support structure 160 supports positions of the ends of the cables 102 for connection to the circuit card 140. In an exemplary embodiment, the cable support structure 160 includes a cable holder 162 having cable channels 164 that receive the corresponding cables 102 to hold relative positions of the cables 102. The cable channels 164 may be arranged in multiple rows. The cable holder 162 may provide strain relief for the cables 102. In various embodiments, the cable holder 162 may be formed in place over the cables 102. For example, the cable holder 162 may be overmolded over the cables 102. Alternatively, the cable holder 162 may be preformed and the cables 102 may be loaded through the cable channels 164. In an exemplary embodiment, the cable support structure 160 includes an outer shell 166. The outer shell 166 includes an opening 168 that receives the cable holder 162. The outer shell 166 may surround the cable holder 162 on multiple sides, such as on all four sides. The outer shell 166 is configured to be coupled to the connector housing 120. For example, the outer shell 166 may be received in the shroud 138.

In an exemplary embodiment, the ground cages 500 are manufactured from multiple pieces. For example, each ground cage 500 includes a ferrule 510 and a cover 550 configured to be coupled together to provide circumferential shielding around the ends of the cables 102 and the contact modules 400. The ferrule 510 may be a stamped and formed element configured to receive the end of the cable 102 and/or at least a portion of the contact module 400. The cover 550 may be a stamped and formed element configured to cover the end of the cable 102 and/or the contact module 400. The ferrule 510 is configured to be electrically connected to the cable shield 106, such as at multiple points of contact (for example, along the bottom and/or the right side and/or the left side of the cable). The cover 550 is configured to be electrically connected to the cable shield 106, such as at one or more points of contact (for example, at a top of the cable). The cover 550 is configured to be electrically connected to the ferrule 510, such as being soldered to the ferrule 510 or attached by a press fit or compression connection. The cover 550 is configured to be electrically connected to the housing 300, such as being soldered, press-fit or connected by other means. The ferrule 510 is configured to be electrically connected to the housing 300, such as being soldered, press-fit or connected by other means. In an exemplary embodiment, the ground cage 500 is used to electrically connect to the cable 102, such as to improve electrical performance of the cable connector module 110. For example, the ground cage 500 may reduce excess insertion loss and cross talk due to tighter control of electromagnetic fields at the termination area. The ground cage 500 may electrically connect to the cable 102 at multiple locations. For example, the ground cage 500 may electrically connect at the top, the bottom and both sides to provide nearly circumferential connection between the cable 102 and the ground cage 500. The ground cage 500 provides a short ground return path between the cable 102 and the circuit card 140 for improved electrical characteristics. The ground cage 500 cooperates with the housing 300 to provide shielding at the transition between the cables 102 and the circuit card 140, such as along the ends of the cables 102 and along the contact modules 400.

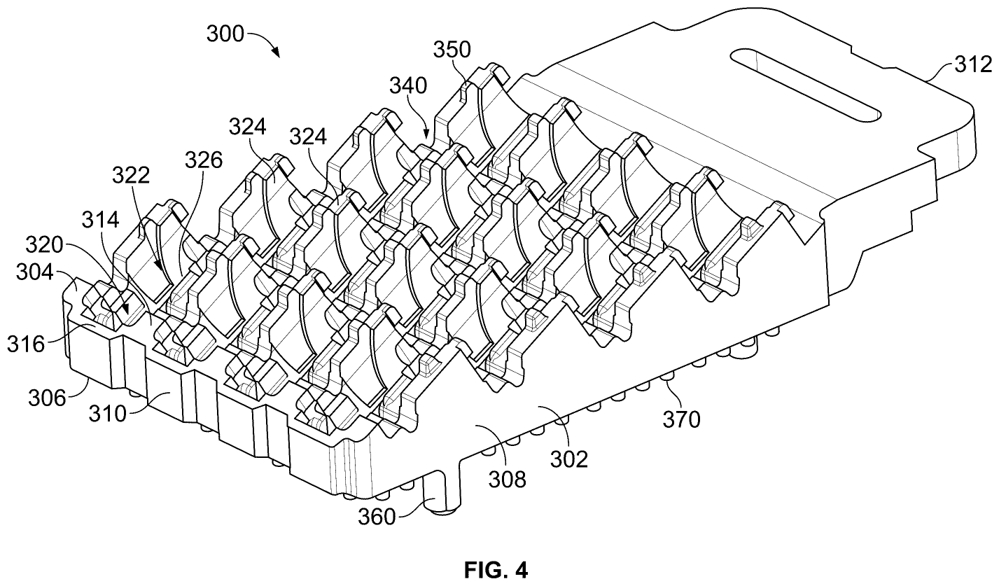

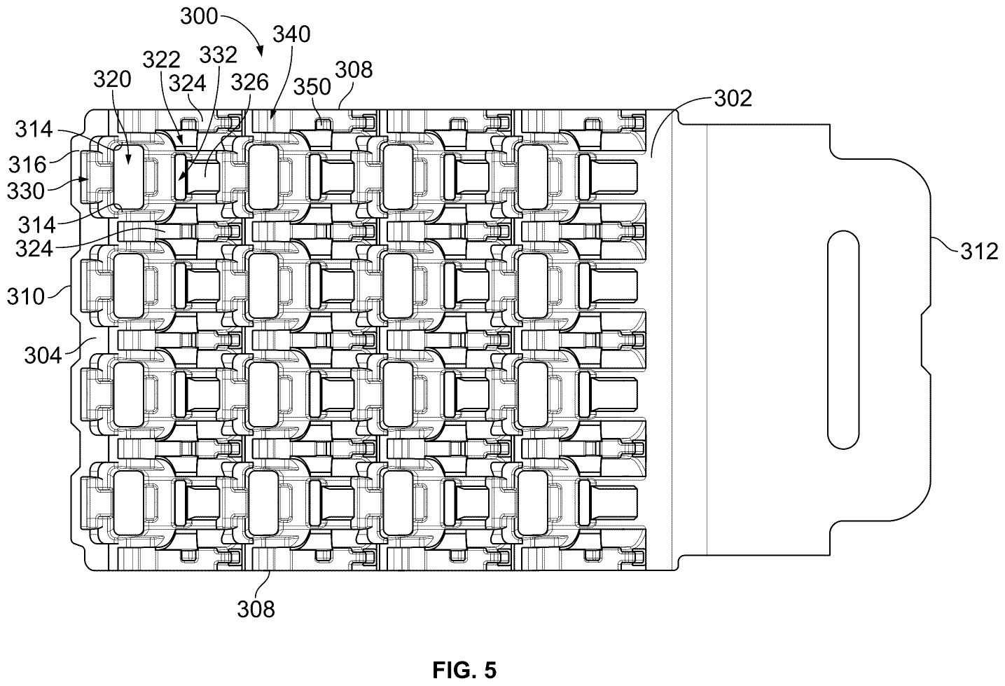

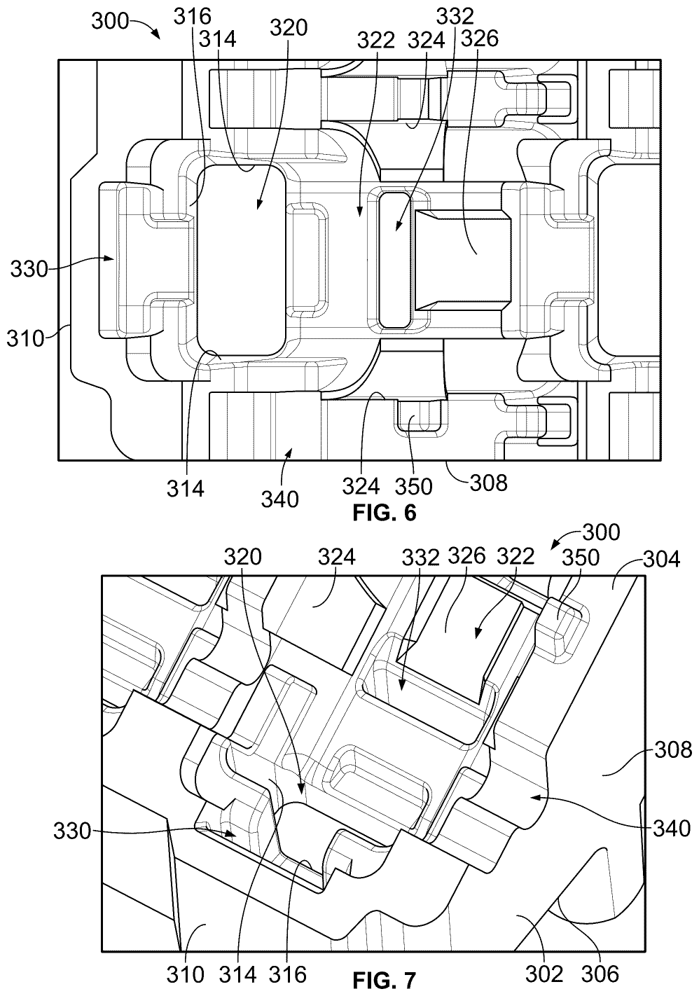

FIG. 4 is a perspective view of the housing 300 in accordance with an exemplary embodiment. FIG. 5 is a top view of the housing 300 in accordance with an exemplary embodiment. FIG. 6 is a top view of a portion of the housing 300 in accordance with an exemplary embodiment. FIG. 7 is a top perspective view of a portion of the housing 300 in accordance with an exemplary embodiment.

The housing 300 includes a platform 302 having a top 304 and a bottom 306. The contact pockets 320 pass through the platform 302 between the top 304 and the bottom 306 and are configured to hold the corresponding contact modules 400 (shown in FIG. 3). The platform 302 includes sides 308 that extend between the top 304 and the bottom 306. The platform 302 extends between a front 310 and a rear 312. The platform 302 includes side walls 314 and end walls 316 forming the contact pockets 320. The contact pockets 320 are arranged in multiple rows between the front 310 and the rear 312. The end walls 316 are arranged between the rows of the contact pockets 320 and the side walls 314 are arranged between the contact pockets 320 within each of the rows. In the illustrated embodiment, the contact pockets 320 are arranged in four rows each having four contact pockets 320. The housing 300 may include greater or fewer rows of the contact pockets 320 and/or may include greater or fewer contact pockets 320 in each row.

In an exemplary embodiment, the housing 300 includes cable pockets 322 extending rearwardly from each of the contact pockets 320. The cable pockets 322 are configured to support the cables 102 extending from each of the corresponding contact modules 400. The cable pockets 322 are formed by side walls 324 and base walls 326. The side walls 324 are arranged between the cable pockets 322 in each row. The side walls 324 may be extensions of the side walls 314. The base walls 326 are located at the bottom of each cable pocket 322 extending between the side walls 324. The base walls 326 extend between the contact pockets 320, such as between the contact pockets 320 and the end walls 316 of the contact pockets 320 in the adjacent row. The base walls 326 may define the top sides of the end walls 316. The cable pockets 322 may be angled away from the contact pockets 320 to support the cables 102 extending from the contact modules 400 at an angle.

In an exemplary embodiment, the housing 300 includes forward slots 330 forward of each of the contact pockets 320 and the rearward slots 332 rearward of each of the contact pockets 320. The slots 330, 332 are configured to receive portions of the ground cages 500. For example, portions of the ground cages 500 may be press-fit into the slots 330, 332. The slots 330, 332 are open at the top 304 the platform 302 to receive the ground cages 500. In the illustrated embodiment, the forward slots 330 are located in corresponding end walls 316 and the rearward slots 332 are located in corresponding base walls 326. Other locations are possible in alternative embodiments. The housing 300 may include other slots at other locations configured to receive portions of the ground cages 500.

In an exemplary embodiment, the housing 300 includes solder wells 340. The solder wells 340 are configured to receive solder for soldering the ground cages 500 to the housing 300. In the illustrated embodiment, the solder wells 340 are located in the side walls 314 and/or the side walls 324. Other locations are possible in alternative embodiments. In an exemplary embodiment, the solder wells 340 are open at the top 304 to receive the solder. The solder wells 340 may be opened at one or both sides for soldering to the ground cages 500. For example, the solder wells 340 may be open to the contact pockets 320 and/or the cable pockets 322.

In an exemplary embodiment, the housing 300 includes connecting tabs 350 at the top 304. The connecting tabs 350 are configured to be coupled to the corresponding ground cages 500. In the illustrated embodiment, the connecting tabs 350 extend from the side walls 314 and/or the side walls 324. Other locations are possible in alternative embodiments.

In an exemplary embodiment, the housing 300 includes locating posts 360 extending from the bottom 306 of the platform 302. The locating posts 360 are used to locate or position the housing 300 relative to the circuit card 140 or other components that the housing 300 is coupled to, such as the second electrical connector 200.

In an exemplary embodiment, the housing 300 includes ground posts 370 extending from the bottom 306 of the platform 302. The ground posts 370 are configured to be electrically connected to the circuit card 140, such as the ground plane 148 of the circuit card 140. The ground posts 370 may be soldered to the ground plane 148 of the circuit card 140. Other types of grounding features may be used in alternative embodiments, such as press-fit pins, ground beams, or other types of grounding features. In an exemplary embodiment, the ground posts 370 surrounded each of the contact pockets 320. For example, the ground posts 370 may form a picket fence arrangement surrounding each of the contact pockets 320. The ground posts 370 are separated by a spacing or distance small enough to prevent electromagnetic radiation leakage through the gaps between the ground posts 370 to provide effective electrical shielding around the contact pockets 320 and the contact modules 400 received in the contact pockets 320, such as to minimize inter-pair coupling.

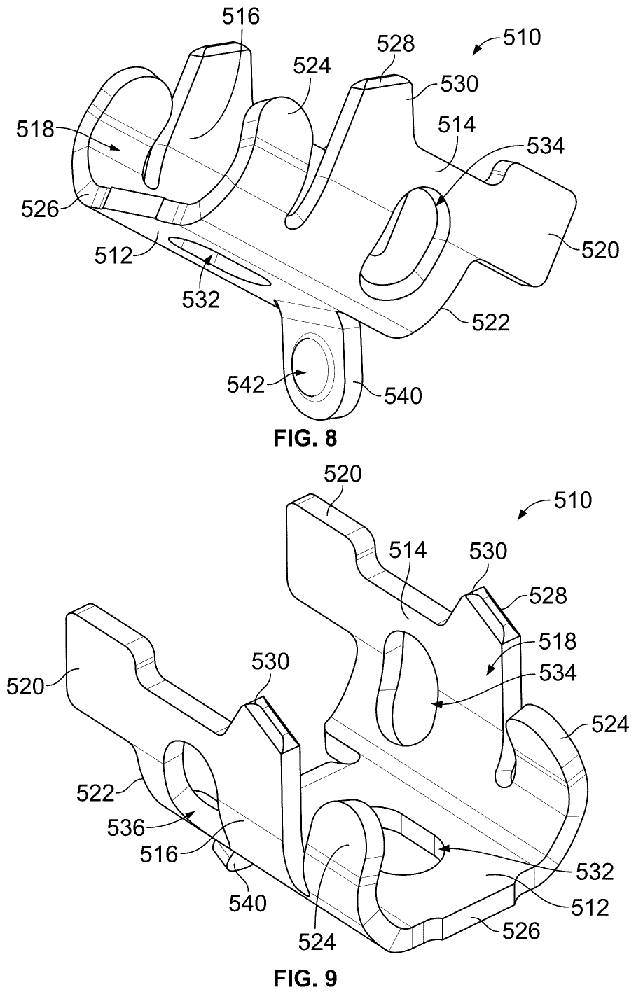

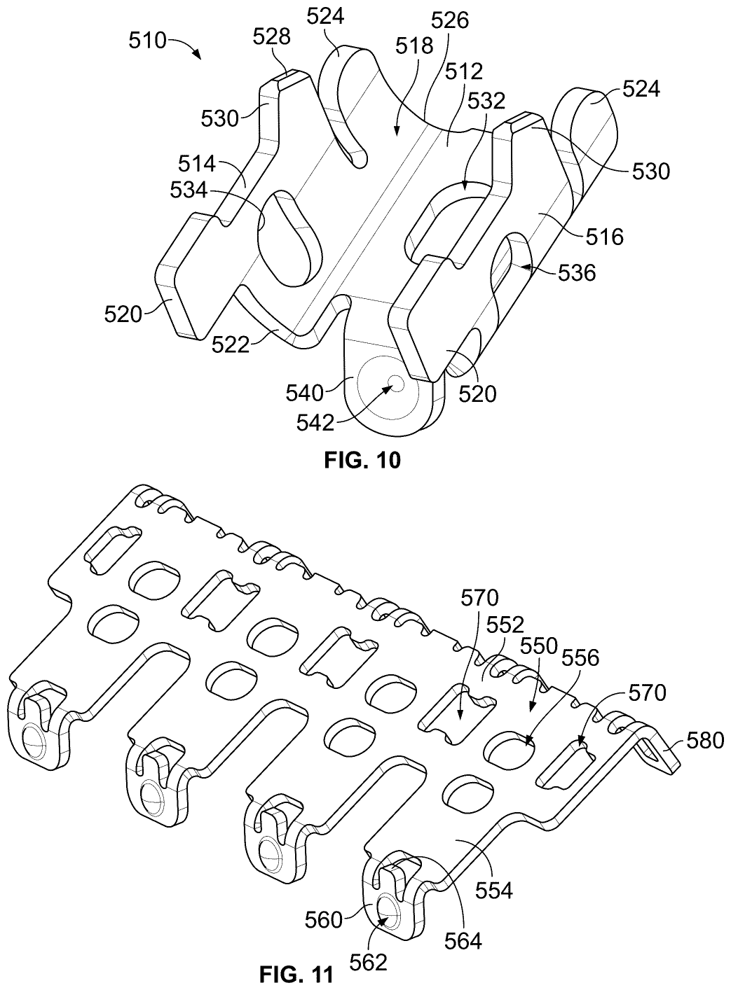

FIG. 8 is a rear perspective view of the ferrule 510 in accordance with an exemplary embodiment. FIG. 9 is a top perspective view of the ferrule 510 in accordance with an exemplary embodiment. FIG. 10 is a front perspective view of the ferrule 510 in accordance with an exemplary embodiment. The ferrule 510 is manufactured from a conductive material, such as a metal material. For example, the ferrule 510 may be manufactured from a copper or copper alloy material. In an exemplary embodiment, the ferrule 510 is a stamped and formed part.

The ferrule 510 includes a bottom wall 512, a first side wall 514 extending from a first side of the bottom wall 512, and a second side wall 516 extending from a second side of the bottom wall 512. The ferrule 510 includes a cradle 518 formed by the bottom wall 512, the first side wall 514, and the second side wall 516. The cradle 518 receives the cable 102. The cradle 518 is open at the top between the first and second side walls 514, 516 to receive the cable 102. The bottom wall 512 is used to engage in support a bottom of the cable 102. The first side wall 514 is used to engage in support a first side of the cable 102. The second side wall 516 is used to engage and support a second side of the cable 102. In the illustrated embodiment, the first and second side walls 514, 516 extend generally perpendicular from the bottom wall 512. The corners where the first and second side walls 514, 516 intersect with the bottom wall 512 may be curved, such as generally following a curvature of the cable 102.

In an exemplary embodiment, the ferrule 510 includes shield walls 520 at a front 522 of the ferrule 510. The shield walls 520 extend forward from the first and second side walls 514, 516. The shield walls 520 may support portions of the cable 102 and/or the contact module 400. The shield walls 520 may be coupled to the housing 300.

In an exemplary embodiment, the ferrule 510 includes crimp tabs 524 and a rear 526 of the ferrule 510. The crimp tabs 524 extend from the bottom wall 512. The crimp tabs 524 are located rearward of the side walls 514, 516. The crimp tabs 524 are configured to be crimped to the cable 102 to mechanically secure the ferrule 510 to the end of the cable 102. The crimp tabs 524 may be electrically connected to the cable 102, such as by crimping to the cable shield of the cable 102.

In an exemplary embodiment, the ferrule 510 includes connecting tabs 530 extending from the side walls 514, 516. The connecting tabs 530 are located at the top of the ferrule 510. The connecting tabs 530 are configured to be connected to the cover 550 of the ground cage 500. In the illustrated embodiment, the connecting tabs 530 are triangular-shaped. However, the connecting tabs 530 may have other shapes in alternative embodiments. The connecting tabs 530 may include dimples or spring beams configured to form a mechanical press-fit connection with the cover 550. In an exemplary embodiment, each connecting tab 530 includes a press surface 528 along the top surface of the connected tab 530. The press surface 528 may be used to press the ferrule 510 into the housing 300 during assembly.

In an exemplary embodiment, the ferrule 510 includes one or more solder windows 532 in the bottom wall 512. The solder window 532 is configured to receive solder to electrically connect the bottom wall 512 of the ferrule 510 to the cable shield 106 at the bottom of the cable 102. In an exemplary embodiment, the ferrule 510 includes one or more solder windows 534 in the first side wall 514. The solder window 534 is configured to receive solder to electrically connect the first side wall 514 of the ferrule 510 to the cable shield 106 at the first side of the of the cable 102. In an exemplary embodiment, the ferrule 510 includes one or more solder windows 536 the second side wall 516. The solder window 536 is configured to receive solder to electrically connect the second side wall 516 of the ferrule 510 to the cable shield 106 at the second side of the of the cable 102.

In an exemplary embodiment, the ferrule 510 includes a ferrule tab 540 extending from one of the walls, such as the bottom wall 512. The ferrule tab 540 may extend downward from the bottom wall 512 at an angle. The ferrule tab 540 is configured to be coupled to the housing 300. For example, the ferrule tab 540 may be press-fit into a slot or opening in the housing 300. The ferrule tab 540 creates a mechanical connection to the housing 300. The ferrule tab 540 may create an electrical connection to the housing 300. In the illustrated embodiment, the ferrule tab 540 includes a dimple 542 configured to be press-fit into the housing 300. The ferrule tab 540 may include other connecting elements, such as a deflectable spring beam or a compliant pin, such as an eye of the needle pin, configured to be press-fit into the housing 300. The ferrule tab 540 may include barbs or lances configured to dig into the housing 300 to provide mechanical and/or electrical connection to the housing 300.

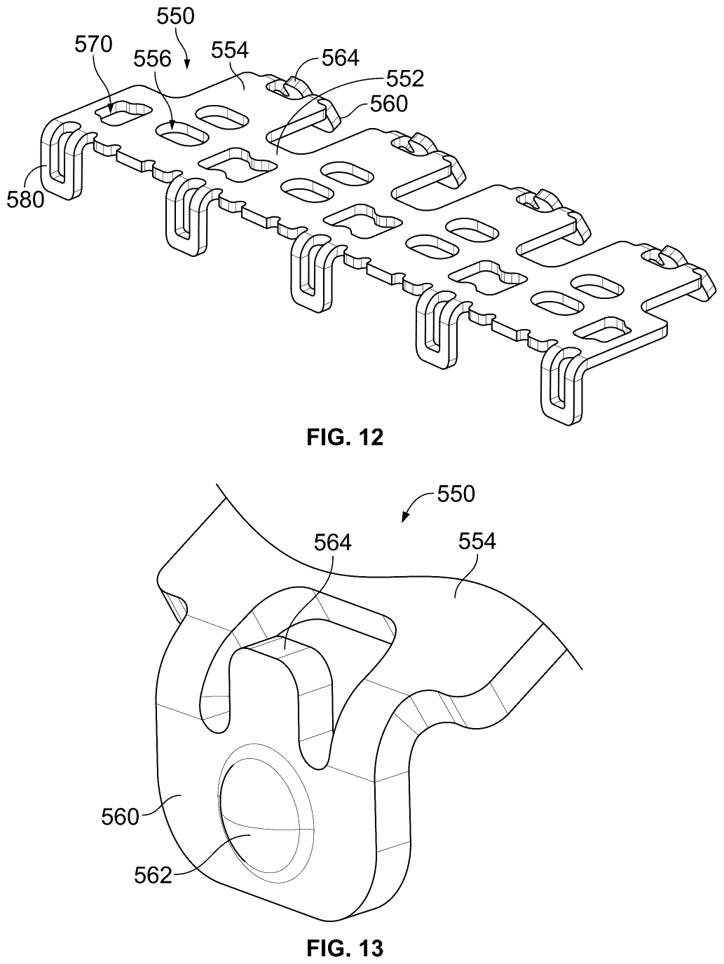

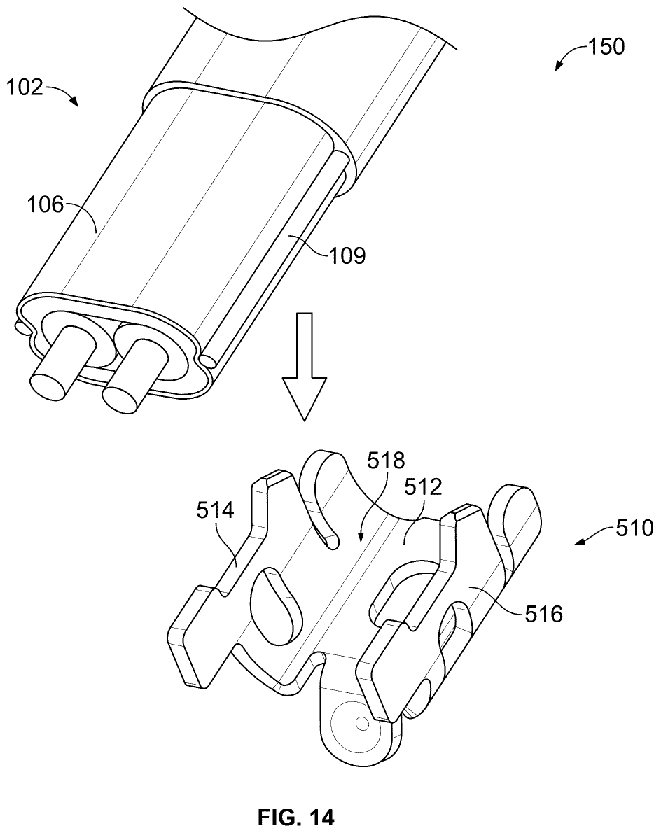

FIG. 11 is a front perspective view of the cover 550 of the ground cage 500 in accordance with an exemplary embodiment. FIG. 12 is a rear perspective view of the cover 550 of the ground cage 500 in accordance with an exemplary embodiment. FIG. 13 is a perspective view of a portion of the cover 550 in accordance with an exemplary embodiment. In an exemplary embodiment, a plurality of the covers 550 are ganged together in a strip configured to be coupled to the housing 300 in the corresponding ferrules 510 as a unit. However, in alternative embodiments, individual covers 550 may be provided for connection to the housing 300 and the corresponding ferrules 510.

The cover 550 is manufactured from a conductive material, such as a metal material. For example, the cover 550 may be manufactured from a copper or copper alloy material. In an exemplary embodiment, the cover 550 is a stamped and formed part. A plurality of the covers 550 may be stamped from a single metal sheet and connected by tie bars 552.

The cover 550 includes a cover wall 554 configured to extend along the top of the cable 102 and the corresponding ferrule 510 to cover the top of the cable 102. In an exemplary embodiment, the cover wall 554 includes one or more solder windows 556 passing therethrough configured to receive solder to solder the cover wall 554 to the top side of the cable 102. The cover 550 may include additional walls in alternative embodiments, such as side walls configured to extend along sides of the cable 102.

In an exemplary embodiment, the cover 550 includes a cover tab 560 extending from the cover wall 554. In the illustrated embodiment, the cover tab 560 extends from the front of the cover wall 554. Other locations are possible in alternative embodiments. The cover tab 560 may extend downward from the cover wall 554 at an angle. The cover tab 560 is configured to be coupled to the housing 300. For example, the cover tab 560 may be press-fit into a slot or opening in the housing 300. The cover tab 560 creates a mechanical connection to the housing 300. The cover tab 560 may create an electrical connection to the housing 300. In the illustrated embodiment, the cover tab 560 includes a dimple 562 configured to be press-fit into the housing 300. The cover tab 560 may include other connecting elements, such as a deflectable spring beam or a compliant pin, such as an eye of the needle pin, configured to be press-fit into the housing 300. The cover tab 560 may include barbs or lances configured to dig into the housing 300 to provide mechanical and/or electrical connection to the housing 300. In an exemplary embodiment, the cover tab 560 includes a press surface 564 along the top surface of the cover tab 560. The press surface 564 may be used to press the cover 550, and the cover tab 560, into the housing 300 during assembly.

In an exemplary embodiment, the cover 550 includes openings 570 through the cover wall 554. The openings 570 are configured to receive the connecting tabs 530 of the ferrule 510 to connect the cover 550 to the ferrule 510. The openings 570 may receive the connecting tabs 350 of the housing 300 to connect the cover 550 to the housing 300. Optionally, the openings 570 may be sized to receive both the connecting tabs 530 of the ferrule 510 and the connecting tabs 350 of the housing 300. However, in alternative embodiments, different openings 570 may be provided to receive the connecting tabs 530 and the connecting tabs 350 in the different openings 570.

In an exemplary embodiment, the cover 550 includes a latch 580 for latching the cover 550 to the housing 300. The latch 580 may be a deflectable latch. The latch 580 is located at the rear of the cover 550. Other locations are possible in alternative embodiments. Other types of security features may be used in alternative embodiments. The cover 550 may be provided without the latch 580 in alternative embodiments.

FIG. 14 illustrates a portion of the cable assembly 150 showing the cable 102 poised for loading into the ferrule 510 in accordance with an exemplary embodiment. The cable 102 is configured to be aligned with the cradle 518. The cable 102 may be lowered into the cradle 518 from above. The bottom of the cable 102 is configured to rest on the bottom wall 512 of the ferrule 510. The cable 102 is configured to be positioned between the first and second side walls 514, 516. In an exemplary embodiment, the stripped end of the cable 102 is received in the ferrule 510 such that the ferrule 510 may be electrically connected to the cable shield 106 and the drain wires 109 of the cable 102. The drain wires may be removed or the connector system may use drainless cables.

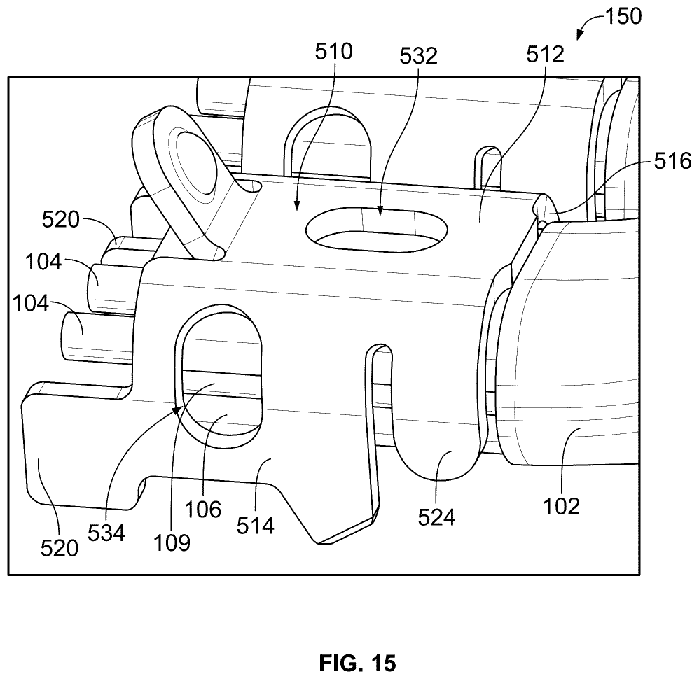

FIG. 15 illustrates a portion of the cable assembly 150 showing the cable 102 loaded into the ferrule 510 in accordance with an exemplary embodiment. During assembly, once the cable 102 is positioned in the cradle 518, the crimp tabs 524 may be crimped around the cable 102 to secure the ferrule 510 to the end of the cable 102. The bottom wall 512 extends along the bottom of the cable 102 and the side walls 514, 516 extend along the sides of the cable 102. The shield walls 520 extend forward from the side walls 514, 516 to extend along the exposed portions of the conductors 104 of the cable 102. The shield walls 520 provide in-line shielding between the pairs of the conductors 104. In an exemplary embodiment, when the cable 102 is received in the cradle 518, the ferrule 510 may be soldered to the cable shield 106 and the drain wires 109 of the cable 102. For example, the solder windows 532, 534, 536 may receive solder to create soldered connections between the ferrule 510 and the cable 102. Multiple solder connections are provided utilizing the multiple solder windows 532, 534, 536. The solder connections are provided at multiple locations around the cable 102, such as at the bottom and along both sides of the cable 102 to create a reliable connection between the cable 102 and the ferrule 510.

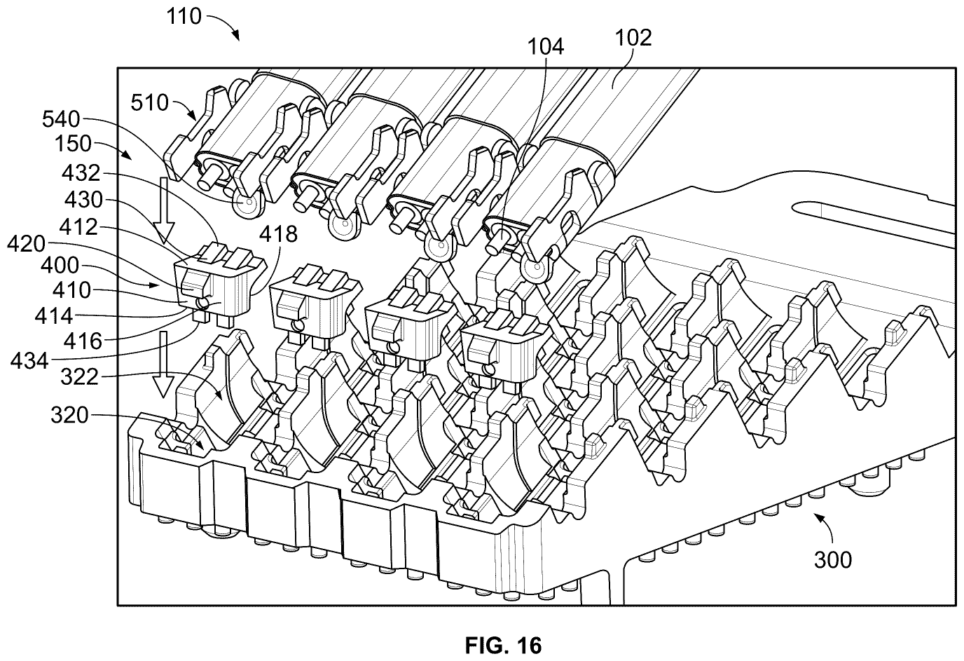

FIG. 16 illustrates a portion of the cable connector module 110 in accordance with an exemplary embodiment showing a plurality of the contact modules 400 poised for loading into the housing 300 and showing a plurality of the cable assemblies 150 poised for loading into the housing 300. During assembly, the contact modules 400 are aligned with the contact pockets 320 in the housing 300. The contact modules 400 may be loaded into the contact pockets 320 from above.

Each contact module 400 includes the contact holder 410 holding the corresponding contacts 430, such as a pair of the contacts 430. The contact holder 410 extends between a top 412 and a bottom 414. The contact holder 410 includes a front 416 and a rear 418. In an exemplary embodiment, the contact holder 410 includes one or more securing features 420 used to secure the contact holder 410 in the contact pocket 320 of the housing 300. In the illustrated embodiment, the securing features 420 include compression tabs configured to be held in the contact pocket 320 by a compression fit. Other types of securing features 420 may be used in alternative embodiments, such as crush ribs, clips, latches, fasteners, heatstakes, and the like.

The contacts 430 pass through the contact holder 410. In various embodiments, the contact holder 410 may be formed in place around the contacts 430, such as being overmolded around the contacts 430. In alternative embodiments, the contacts 430 may be inserted into the contact holder 410, such as into channels formed in the contact holder 410. Each contact 430 includes a connecting end 432 and a terminating end 434. The connecting end 432 is configured to be mated to the circuit card 140 or directly to the second electrical connector 200 when the circuit card 140 is eliminated. In the illustrated embodiment, the connecting end 432 includes a solder tail configured to be soldered to the corresponding pad of the circuit card 140. However, other types of connecting ends may be used in alternative embodiments, such as a press-fit pin, a spring beam, a pin, a socket, or another type of connecting end. The connecting end 432 is exposed below the bottom 414 of the contact holder 410 for connection to the circuit card 140 or the second electrical connector 200. In the illustrated embodiment, the connecting end 432 is oriented vertically. However, in alternative embodiments, the connecting end 432 may be bent at an angle, such as bent 90° to extend horizontally for mating with the circuit card 140.

The terminating end 434 is configured to be electrically connected to the corresponding conductor 104 of the cable 102. In the illustrated embodiment, the terminating end 434 includes a pad configured to be soldered or welded to the conductor 104. Other types of terminating ends may be provided in alternative embodiments, such as a crimped barrel, and IDC connector, and the like. The terminating end 434 is exposed above the top 412 of the contact holder 410 for connection to the conductor 104 of the cable 102. In the illustrated embodiment, the terminating end 434 is bent at an angle relative to the connecting end 432 for connection to the conductor 104 of the cable 102. For example, the terminating end 434 may be bent at an angle corresponding to the exit angle of the cable 102 to allow the conductors 104 to extend parallel to the axis of the cable 102. In the illustrated embodiment, the terminating end 434 is at an angle of between 30° and 60° relative to the vertical axis, however the terminating end 434 may be oriented at other angles, such as any angle between 0° and 90°. Other angles are possible in alternative embodiments. In various embodiments, the terminating end 434 may be oriented vertically, such as being parallel to the connecting end 432.

The cable assemblies 150 are aligned with the corresponding cable pockets 322 in the housing 300. The ferrule 510 and the end of the cable 102 is configured to be received in the corresponding cable pocket 322. The ferrule 510 and the end of the cable 102 may be loaded into the cable pocket 322 from above. The ferrule tab 540 is configured to be loaded into the housing 300, such as into the corresponding slot 332 in the housing 300.

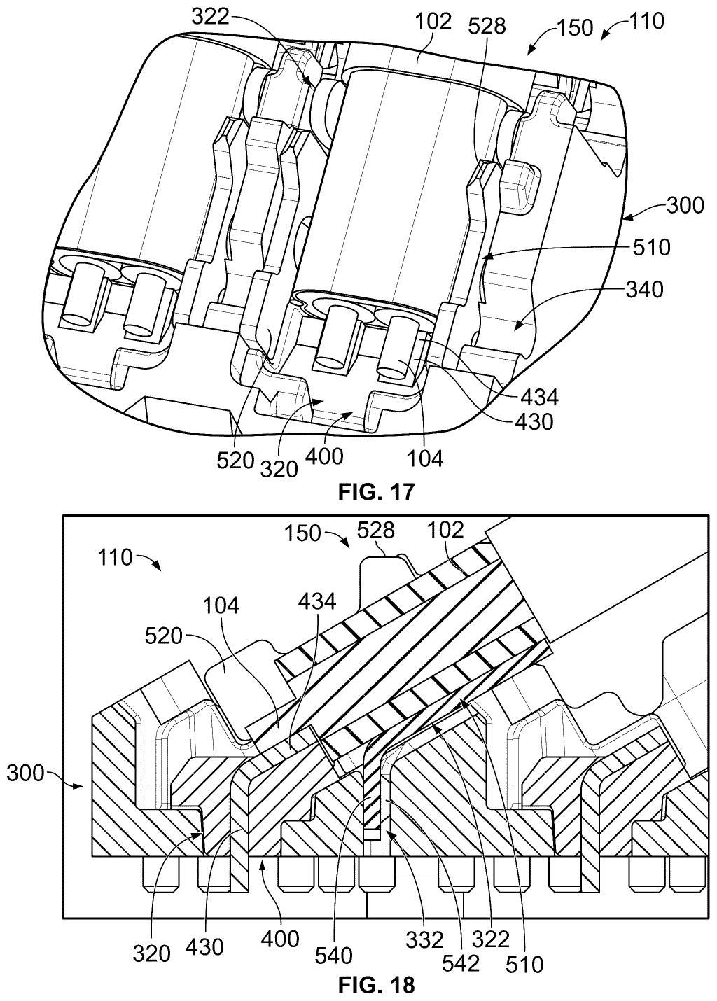

FIG. 17 illustrates a portion of the cable connector module 110 in accordance with an exemplary embodiment showing the contact module 400 and the cable assembly 150 loaded into the housing 300. FIG. 18 is a cross-sectional view of a portion of the cable connector module 110 in accordance with an exemplary embodiment showing the contact module 400 and the cable assembly 150 loaded into the housing 300. The contact module 400 is received in the corresponding contact pocket 320. The cable assembly 150 is received to the corresponding cable pocket 322.

In an exemplary embodiment, a tool may be used to press the ferrule 510 into the housing 300. For example, the tool may press against the press surface 528 at the top of the connecting tab 530 to press the ferrule 510 (for example, the ferrule tab 540) into the housing 300. Optionally, the press surface 528 may be aligned vertically above the ferrule tab 540 such that downward pressure on the press surface 528 is transferred through the ferrule 510 to load the ferrule tab 540 into the corresponding slot 332 in the housing 300. The dimple 542 creates a compression connection between the ferrule tab 540 and the housing 300.

When assembled, the conductors 104 of the cable 102 are aligned with the terminating ends 434 of the contacts 430. The conductors 104 may be soldered or welded (for example, a laser welded) to the contacts 430. The shield walls 520 provide shielding between the pairs of the conductors 104.

In an exemplary embodiment, the ferrule 510 may be electrically connected to the housing 300. For example, the ferrule 510 may be soldered to the housing 300. In an exemplary embodiment, the solder wells 340 may be filled with solder to create a soldered connection between the ferrule 510 and the housing 300.

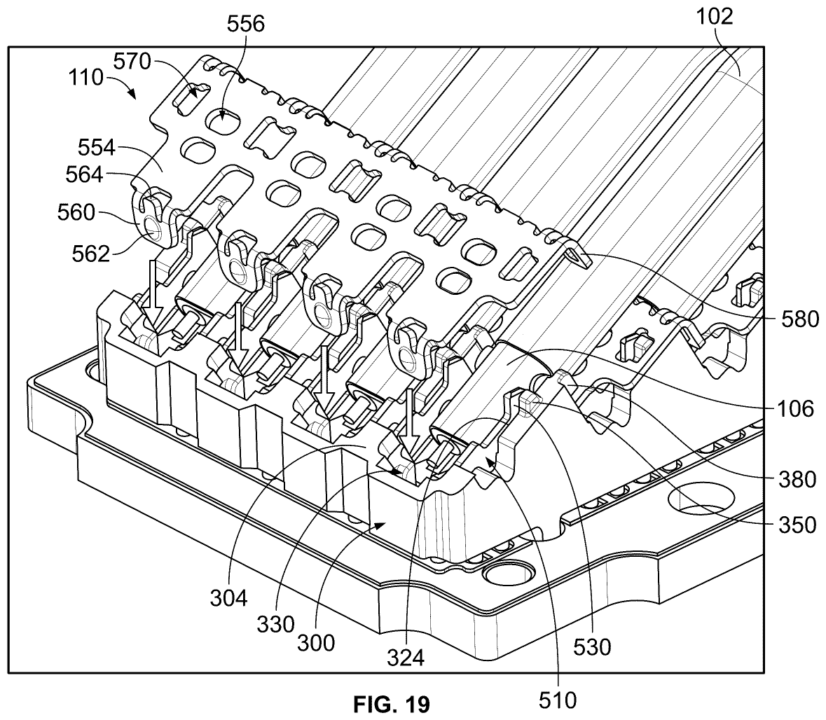

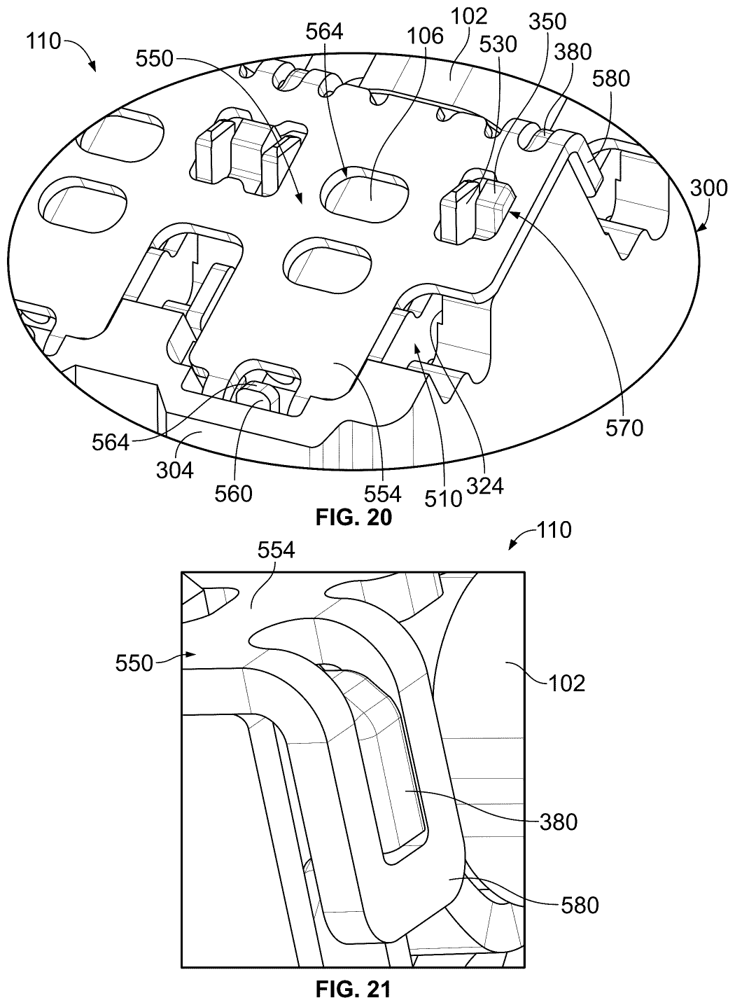

FIG. 19 illustrates a portion of the cable connector module 110 in accordance with an exemplary embodiment showing the cover 550 poised for coupling to the housing 300. FIG. 20 illustrates a portion of the cable connector module 110 in accordance with an exemplary embodiment showing the cover 550 coupled to the housing 300. FIG. 21 illustrates a portion of the cable connector module 110 in accordance with an exemplary embodiment showing the cover 550 coupled to the housing 300.

During assembly, the cover 550 is aligned with the corresponding ferrule 510 and the cable 102. The cover 550 may be assembled from above. For example, the cover 550 may be plugged into the top 304 of the housing 300. The cover wall 554 covers the top of the cable 102. The cover tab 560 is aligned with the corresponding slot 330 in the housing 300 and is configured to be plugged into the slot 330. In an exemplary embodiment, a tool may be used to press the cover 550 into the housing 300. For example, the tool may press against the press surface 564 at the top of the cover tab 560 to press the cover tab 560 into the slot 330 in the housing 300. Optionally, the press surface 564 may be aligned vertically above the cover tab 560 such that downward pressure on the press surface 564 is transferred through the cover tab 560 to load the cover tab 560 into the corresponding slot 330 in the housing 300. The dimple 562 creates a compression connection between the cover tab 560 and the housing 300. In an exemplary embodiment, the latch 580 is configured to be electrically coupled to a latch element 380 at the rear of the side wall 324. The latch 580 secures the rear of the cover 550 to the housing 300.

In an exemplary embodiment, when the cover 550 is coupled to the housing 300, the cover 550 may be soldered to the cable shield 106 of the cable 102. For example, the solder windows 556 may receive solder to create soldered connections between the cover 550 and the cable 102. Multiple solder connections may be provided utilizing the multiple solder windows 556 to space apart the connection points between the cover 550 and the cable 102 to create a reliable connection between the cable 102 and the cover 550. The multiple connection points are provided around the cable shield 106, such as on all four sides of the cable shield 106 and at sufficiently small spacings therebetween to efficiently common the ground cage 500 and the cable shield 106 allowing efficient operation at high frequencies for high-speed operation, such as at 224 Gbps.

In an exemplary embodiment, when the cover 550 is coupled to the housing 300, the openings 570 receive the connecting tabs 530 of the ferrule 510 to connect the cover 550 to the ferrule 510. For example, the connecting tabs 530 may be soldered or welded (for example, laser welded) to the cover 550. In an exemplary embodiment, the openings 570 receive the connecting tabs 350 of the housing 300 to connect the cover 550 to the housing 300. For example, the connecting tabs 350 may be soldered or welded (for example, laser welded) to the cover 550.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A cable connector module comprising:
a housing including contact pockets;
contact modules received in the corresponding contact pockets, each contact module including a contact holder holding contacts in pairs, each contact including a connecting end configured to be mated with a mating conductor and a terminating end opposite the connecting end;
cables having cable ends terminated to the contact modules, each cable including a pair of signal conductors, the signal conductors terminated to the terminating ends of the corresponding contacts to electrically connect the cables to the corresponding contact modules, each cable having a cable shield surrounding the pair of signal conductors;
ground cages associated with the cables and the corresponding contact modules, each ground cage providing circumferential shielding around the cable end of the corresponding cable and around the contact modules, the ground cage being electrically connected to the cable shield of the corresponding cable, the ground cage being mechanically coupled to the housing.

2. The cable connector module of claim 1, wherein the housing is conductive, the ground cages being electrically connected to the housing to electrically connect the housing to the cable shields.

3. The cable connector module of claim 1, wherein the housing includes a platform having a top surface and a bottom surface, the contact pockets extending through the platform between the top surface and the bottom surface, the platform including cavities receiving the ground cages.

4. The cable connector module of claim 3, wherein the ground cages are press fit into the cavities to mechanically and electrically connect to the housing.

5. The cable connector module of claim 3, wherein the ground cages are soldered into the cavities to mechanically and electrically connect to the housing.

6. The cable connector module of claim 1, wherein each ground cage includes a ferrule and a cover coupled to the ferrule, the ferrule including a bottom wall, a first side wall extending from a first side of the bottom wall, and a second side wall extending from a second side of the bottom wall, the bottom wall, the first side wall, and the second side wall forming a cradle receiving the cable end of the corresponding cable, the cover coupled to the first and second side walls to cover the cradle.

7. The cable connector module of claim 6, wherein the ferrule includes solder windows in the bottom wall, the first side wall, and the second side wall configured to receive solder to solder the ferrule to the cable shield at the bottom, the first side, and the second side, respectively, of the cable shield.

8. The cable connector module of claim 6, wherein the cover includes a solder window in the top wall configured to receive solder to solder the cover to the cable shield at the top of the cable shield.

9. The cable connector module of claim 6, wherein the cover includes openings, the ferrule including connecting tabs extending from the first and second side walls, the connecting tabs received in the corresponding openings of the cover to connect the cover to the ferrule, the connecting tabs being one of soldered or welded to the cover.

10. The cable connector module of claim 7, wherein the housing includes connecting tabs received in the corresponding openings of the cover to connect the cover to the housing, the connecting tabs of the housing being one of soldered or welded to the cover.

11. The cable connector module of claim 6, wherein the ferrule includes a ferrule tab received in a cavity of the housing and the cover includes a cover tab received in a cavity of the housing.

12. The cable connector module of claim 11, wherein the ferrule tab and the cover tab are press fit into the housing to mechanically and electrically connected to the housing.

13. The cable connector module of claim 11, wherein the ferrule tab and the cover tab include deflectable beams deflected against the housing to mechanically and electrically connect to the housing.

14. The cable connector module of claim 6, wherein the housing includes solder wells configured to receive solder to electrically connect the ferrule to the housing.

15. The cable connector module of claim 1, wherein the contact holder includes a dielectric block overmolded over the pair of contacts to hold the relative positions of the contacts, the ground cage extending along portions of the corresponding dielectric block.

16. The cable connector module of claim 1, wherein the signal conductors are soldered to the terminating ends of the corresponding contacts.

17. The cable connector module of claim 1, wherein the contact pockets are arranged in an array in multiple rows with separating walls between the contact pockets, the cables arranged in multiple rows extending from the contact modules arranged in the array of the contact pockets.

18. The cable connector module of claim 1, wherein further comprising a cable holder having cable channels receiving the corresponding cables to hold relative positions of the cables.

19. A cable connector module comprising:
a circuit card and a cable assembly coupled to the circuit card;
the circuit card including a substrate having contact pads;
the cable assembly comprising:
a housing mounted to the substrate, the housing including contact pockets;
contact modules received in the corresponding contact pockets, each contact module including a contact holder holding contacts in pairs, each contact including a connecting end configured to be mated with the corresponding contact pad of the circuit card and a terminating end opposite the connecting end;
cables having cable ends terminated to the contact modules, each cable including a pair of signal conductors, the signal conductors terminated to the terminating ends of the corresponding contacts to electrically connect the cables to the corresponding contact modules, each cable having a cable shield surrounding the pair of signal conductors;
ground cages associated with the cables and the corresponding contact modules, each ground cage providing circumferential shielding around the cable end of the corresponding cable and around the contact modules, the ground cage being electrically connected to the cable shield of the corresponding cable, the ground cage being mechanically coupled to the housing.

20. The cable connector module of claim 19, wherein the contact pads are arranged in pairs surrounded by a ground plane, the housing being conductive providing electrical shielding for each contact module, the housing being electrically connected to the ground plate.

21. The cable connector module of claim 19, wherein the housing is conductive, the ground cages being electrically connected to the housing to electrically connect the housing to the cable shields.

22. A communication system comprising:
a first electrical connector and a second electrical connector configured to be mated at a separable mating interface;
the first electrical connector comprising a cable connector module including a housing including contact pockets, contact modules received in the corresponding contact pockets, cables having cable ends terminated to the contact modules, and ground cages associated with the cables and the corresponding contact modules, each contact module including a contact holder holding contacts in pairs with each contact including a connecting end and a terminating end opposite the connecting end, each cable including a pair of signal conductors, the signal conductors terminated to the terminating ends of the corresponding contacts to electrically connect the cables to the corresponding contact modules, each cable having a cable shield surrounding the pair of signal conductors, each ground cage providing circumferential shielding around the cable end of the corresponding cable and around the contact modules, the ground cage being electrically connected to the cable shield of the corresponding cable, the ground cage being mechanically coupled to the housing; and
the second electrical connector including mating contacts, wherein each mating contact is configured to be electrically connected to the connecting end of the contact of the corresponding contact module.

23. The communication system of claim 22, wherein the second electrical connector includes a socket assembly including a cage configured to be mounted to the circuit board, the cage having a cavity, the socket assembly including a socket connector received in the cavity of the cage, the socket connector including a substrate holding interposer contacts, each interposer contact including an upper contact portion and a lower contact portion, the upper contact portion being compressible and configured to be electrically connected to the corresponding contact of the contact module, the lower contact being compressible and configured to be terminated to a board contact of the circuit board.

24. The communication system of claim 22, wherein the second electrical connector includes a card edge connector having a connector housing including a card slot, the cable connector module including a circuit card having contact pads and mating pads and an edge of the substrate, the connecting ends of the contacts being electrically connected to the contact pads of the circuit card, the edge of the circuit card being plugged into the card slot to mate the mating pads with the mating contacts of the second electrical connector.
